(19) United States
(12) Patent Application Publication
(10) Pub. No.: US 2021/0190962 A1
(43) Pub. Date: Jun. 24, 2021

(54) MULTI-WAVELENGTH LIDAR AND THERMAL IMAGER

(71) Applicant: NETZVISION LLC, Rochester, NY (US)

(72) Inventors: Shimon MAIMON, Rochester, NY (US); Itai MAIMON, Rochester, NY (US); Ory Amos-Haim MAIMON, Rochester, NY (US); Ronit SASON-MAIMON, Rochester, NY (US)

(21) Appl. No.: 17/142,226

(22) Filed: Jan. 5, 2021

Related U.S. Application Data
(63) Continuation-in-part of application No. PCT/US2019/042088, filed on Jul. 16, 2019.
(60) Provisional application No. 62/699,130, filed on Jul. 17, 2018.

(51) Int. Cl. G01S 17/95; G01S 7/484; G01S 17/86; G01S 17/894; G01S 7/481; G01S 7/4865; H04N 5/33

(52) U.S. Cl. CPC G01S 17/95; G01S 7/484; G01S 17/86; H04N 5/33; G01S 7/4815; G01S 7/4865; G01S 17/894

(57) ABSTRACT

Several embodiments of an apparatuses and method for sensing objects in a volume of interest are provided, including optionally sensing weather phenomena such as snow, ice, fog and the like by illuminating the volume with a laser pulse which is highly absorbed by the phenomenon and another laser pulse which is highly reflected, and sensing phenomenon presence by the returned pulses. Another aspect involves LIDAR utilizing a plurality of wavelengths. Further aspect include apparatus combining LIDAR and thermal imaging utilizing a single photodetector biased at different polarities to switch between the LIDAR and thermal imaging modes, providing a 3D thermal map of the volume of interest. All features may be combined in a single embodiment of the invention, or various aspects may be combined at will. A dual polarity photodetector for use in such combined LIDAR and thermal imager is also provided. Methods of using various embodiments are also provided.

### RELATED APPLICATIONS

This application claims the benefit of priority from PCT application No. PCT/US2019/42088, which in turn claims priority from U.S. provisional application No. 62/699,130, both of which are incorporated herein by reference in their entirety.

### FIELD OF THE INVENTION

The present invention relates generally to image detectors and more particularly to image detectors capable of sensing infrared (IR) energy emitted from objects, and laser irradiation reflected from objects, and to methods of using same.

### BACKGROUND

Numerous fields benefit from forming a dynamic three dimensional representation of a certain field of view. By way of example studying a region remotely such as mapping a region which is too dangerous for humans to enter, emergency operations and disaster relief, such as forming three dimensional view of collapsed structures, radioactive structures and the like. Vehicles of all types, such as cars, marine craft, submersibles, and various aircrafts are occasionally operated in reduced visibility environments and accurate information on the vehicle surroundings in one or more directions would often increase the usability and safety of the vehicle as well as its occupants and bystanders. Recent advances in autonomous vehicles of all kinds require information of the vehicle surroundings to allow the vehicle to avoid hitting objects. Especially when relating to autonomous cars and other terrestrial vehicles, precise detection of other vehicles, objects, road and certain road conditions, obstacles, and especially of humans and animals is considered paramount to the success of such vehicle.

Visually based detection range of objects is restricted by numerous phenomena, like snow, heavy rain, clouds, fog, smoke, and dust by way of example, and is clearly limited during darkness. Infrared image detectors are well known for their ability to discern objects by their thermal emission characteristics, as objects emit radiation commonly known as ‘blackbody radiation’ in an amount which is generally proportional to its temperature. Infrared detectors detect such blackbody radiation utilizing an array of IR photodetecting pixels known as a Focal Plan Array (FPA) located at a focal plane of a focusing mechanism. Such FPA is capable of forming a two dimensional image of objects based on their blackbody emission. An object's collective blackbody radiation is colloquially known as its ‘heat signature’, and thermal imagers are devices which form a visual representation of objects heat signatures detected by at least one array of infrared detectors.

While images are read easily by humans, a sensor based image is indeed an electronic signal, and oftentimes is represented digitally, prior to being transferred to the visual range. However for brevity these specification shall interchangeably relate to electronic representation of two dimensional (2D) and/or three dimensional (3D) electronic representation as a ‘map’ and/or as an ‘image’ regardless if the representation is indeed rendered visually or utilized as information for processing purposes. Similarly, for brevity an imager may be considered a device which senses an environment at a field of view utilizing a sensor, and forming a representation of certain parameters of the environment in two and/or three dimensions, regardless of the question if the representation of the sensed environment is actually displayed as an image or not. Furthermore, while different techniques may be utilized to collect information about all or part of the surrounding environment, is assumed that every sensor or sensing method is directed at a specific field of view, which for a specific time forms the area or volume of interest, equivalently referred to as the field of view of interest.

While primarily used in night-vision, thermal imagers can operate in nearly all environmental conditions. Furthermore, thermal imagers are very useful for discerning animate from inanimate objects as well as discerning different materials, such as differentiating between a roadway and a grass strip and the like.

Thermal imagers may be divided into two major categories, namely cooled and uncooled imagers. Generally uncooled thermal imagers are slower and less accurate than cooled thermal imagers; however, they are also less expensive and more efficient. In contrast, cooled thermal imagers are much more accurate and faster than uncooled imagers, but are more expensive and require sophisticated cooling equipment. Cooled thermal imagers are common in higher precision applications, such as military, medical, and other commercial applications, while uncooled thermal imagers are utilized primarily by local police for surveillance, by fire fighters, marine and other short distance thermal imaging. A significant and ongoing thrust in the IR photodetector field involves researching various materials and architectures capable of raising the operating temperature of cooled thermal imagers to achieve higher energy efficiency and to reduce system cost. Generally, thermal imaging is carried on at the mid IR range, such as between 3 μm and 8 μm.

Numerous algorithms are known for identifying humans, animals, and other objects within such image data representation. Many of those algorithms utilize an area of programming known colloquially as ‘Artificial Intelligence’ or ‘AI’. Such software and algorithms are commercially available, are continually developed and improved, and shall not be further investigated in this specification.

LIDAR (Light Detection and Ranging or Laser Imaging Detection and Ranging) is a surveying method similar to the more common Radio Detection and Ranging (RADAR), utilizing irradiation in the light spectrum instead of the much lower frequency radio spectrum. LIDAR detects distance from a target or multiple targets by illuminating the surrounding environment with laser pulses of a given wavelength and measuring the time difference between the transmission of the light pulse to the time the reflected light is detected. This data, known as time-of-flight (TOF), allows the LIDAR to measure the distance to the reflecting target with high accuracy. A common type colloquially known as a scanning LIDAR sends a plurality of laser pulses in a scanning pattern to scan an area of interest. Range information is collected from time-of-flight and correlated with the respective pulse direction. A second type of LIDAR colloquially related to as a flood LIDAR floods the volume of interest by a pulse of laser light, and the LIDAR detects the reflected light by a focal plane array capable of sensing at least the wavelength of the light that was used for flooding the volume. In a flood type LIDAR each pixel may individually capture the time-of-flight. The plurality of direction and range information collected from the reflected laser light pulses can then be used to create a three-dimensional representation of objects in the area of interest.

Conventional LIDARs have two major components, namely a laser light source which emits the pulses, and a photodetector which detects the reflected pulse. Timing circuitry also form a part of the common LIDAR however timing analysis may be carried out by a separate unit which utilize raw timing information. The laser oftentimes emits pulses at different pulse lengths and repetition rates, with shorter pulses affording better resolution. Conventional LIDARs use silicon avalanche photodiodes and/or photomultipliers, to detect and amplify the signal produced by the reflection of the laser pulse.

LIDARs has numerous applications including inter alia astronomy, topography, meteorology, seismology, agriculture and other fields. LIDAR is increasingly used in various types of robots and autonomous vehicles as an accurate way to measure distances and create three-dimensional maps of the robot and/or vehicle surrounding. However LIDAR has certain shortcomings that limit its usability in certain environmental conditions. By way of example one of the main shortcomings of conventional LIDAR is the fact that certain wavelengths of laser light are damaging to human eyes and therefore can only be emitted in very low intensities while humans may be in the vicinity, thus making the LIDAR less accurate. Furthermore, certain wavelengths can be absorbed by common materials and/or environments, such as snow, ice, or water and are therefore ineffective in numerous common environmental conditions.

Identifying the existence of certain whether phenomena and/or specific material in the environment the robot/vehicle operates in is of extreme importance. Furthermore, there are often situations which requires merely an automated sensing of such phenomena in numerous other areas of endeavor, with or without active human presence. By way of example marine navigation may benefit from detection of fogy areas ahead, a task that is not easily achieved by the human eye at night. Similarly, detection of icing conditions on aircraft surfaces is oftentimes difficult, yet the effect of icing the aircraft may be disastrous. Forming a three dimensional (3D) map of certain phenomena at the vicinity of an airport may assist aircrafts traversing the airspace in avoiding icing, visibility restrictions, and other conditions of potential danger.

The term weather phenomena relates to phenomena such as snow, cloud, rain, water, fog, and/or ice and similar phenomena characterized by the presence of liquid, gaseous, or solid water within the environment in a direction within the field of view of interest. For brevity, the term weather phenomena (or phenomenon) shall relate to any and all combinations of such phenomena, as applicable.

There is a long felt but hereto unresolved need for improved environmental sensing in the vicinity of vehicles and especially in the vicinity of autonomous vehicles, and a need for improved detection of the existence of water, snow, and ice by autonomous vehicles, robots, and other machines, as well as by humans.

Thus the output of a sensor capable of resolving those needs may be utilized by a machine or displayed to a human.

A map which combines LIDAR and thermal data into three dimensional representation of a volume of interest, which is the volume confined by the field of view of interest, is referred to in this specification as a 3D thermal map. Forming a three dimensional thermal map is possible utilizing separate LIDAR and thermal sensors, however distance between the sensor and timing considerations make combining the information from both sensors difficult, computationally intensive and error prone. Therefore there is a long felt, yet heretofore unresolved, need for an improved device and/or method which will allow creation of 3D thermal map in a simpler yet accurate manner. A 3D thermal map may also be formed by combining the representation obtained from a LIDAR and thermal information from a plurality of narrower field of view of interest.

### SUMMARY

It is an object of the invention to provide a combination LIDAR and thermal imaging sensor, methods for operating the same, and methods of forming a 3D thermal map of a volume of interest.

It is a farther object of the invention to provide a LIDAR system operable at a plurality of wavelengths.

It is a further object of the invention to provide an apparatus and methods for automated detecting weather phenomena such as rain, snow, fog, ice, and the like, by utilizing differences in the reflection and absorption of differing wavelength laser illumination by such phenomenon. It is further an object of the invention to provide a LIDAR capable of detecting such weather phenomenon.

Yet another object of the invention involves providing a dual-polarity infrared photodetector capable of sensing a thermal image while being biased at a first polarity and of measuring reflected laser pulses of multiple wavelengths while being biased at a second polarity. While being biased at the first polarity the photodetector acts as an infrared detector in the long wave infrared (IR) range (colloquially known as large wave IR or LWIR), the mid wave IR range (MWIR), or the short wave IR (colloquially known as small wave IR, or SWIR). While the photodetector is being biased at the second polarity it will act as a Wide-Range infrared detector for a LIDAR capable of detecting multiple wavelengths of reflected light. More particularly, the second polarity is used to detect reflected laser pulses of multiple wavelengths to determine a distance to a target. A further object of the invention is directed to using such detector in any and all of the embodiments disclosed herein, and/or for obtaining any and all of the objects disclosed herein.

In an aspect of the invention there is provided an apparatus for detecting a weather phenomenon in a volume of interest, the apparatus comprising a first laser emitter capable of illuminating the volume of interest with laser light pulses having a first wavelength, a second laser emitter capable of illuminating the volume of interest with laser light pulses having a second wavelength, a focal plan photodetector comprising a plurality of pixels each pixel being capable of sensing reflected laser light pulses from the first and second emitters respectively, a focusing mechanism capable of focusing reflected light from the volume of interest on the photodetector, such that each pixel receives light from a respective portion of the volume of interest, and a comparator configured to compare relative amplitude of the reflected light of first and second wavelengths detected by the photodetector, the apparatus characterized by the first wavelength having a higher absorption by the weather phenomenon than the second wavelength, and the second wavelength having a higher reflectance rate by the weather phenomenon than the first wavelength.

In certain embodiments the weather phenomenon is selected from ice, snow, fog, rain, cloud, and any combination thereof. Optionally the photodetector comprises a plurality of pixels each receiving light from a respective portion of the volume of interest. Alternatively the photodetector is directed to a narrow field of interest and is capable of sensing the phenomenon in a specified single direction.

In certain embodiments detected amplitude of reflected light of the second wavelength exceeding detected amplitude of the first wavelength by a predetermined level causes indication of the presence of at least one weather phenomenon in the direction. In certain embodiments detection of reflected light of the second wavelength and lack of detection of the first wavelength causes indication of the presence of at least one weather phenomenon in the direction.

Optionally the first wavelength is about 0.9 μm or about 1.8 μm. Further optionally the second wavelength is about 1.55 μm. In some embodiments the laser pulses of the first and second emitters are emitted sequentially.

In certain embodiments the apparatus comprising at least one timer capable of determining time difference between an initiation time of a laser pulse from the first or second emitters and a time when the laser pulse is detected by a pixel of the plurality of pixels, after being reflected from the volume of interest. In other optional embodiments, each of the plurality of pixels comprises a timer capable of determining time difference between an initiation time of a laser pulse from the first or second emitters and a time when the laser pulse is detected by the respective pixel after being reflected from the volume of interest.

Optionally, at least one of the plurality of pixels is capable of detecting infrared energy when the photodetector is biased at a first polarity, and of detecting light at least at the first and second wavelengths when the photodetector is biased at a second polarity. Optionally, the infrared energy is a dark body energy, or stated differently mid-wave IR.

In an aspect of the invention there is provided a method of detecting the existence of a weather phenomenon in an area or volume of interest, the method comprising:
illuminating the area or volume of interest by a laser light of a first wavelength;
sensing the laser light of first wavelength reflected from the area or volume of interest;
illuminating the area or volume of interest by a laser light pulse of a second wavelength;
sensing the laser light of second wavelength reflected from the area or volume of interest;

The method is further characterized by the first wavelength having a higher absorption by the weather phenomenon than the second wavelength, and the second wavelength having a higher reflectance rate by the weather phenomenon than the first wavelength, and indicating the presence of a weather phenomenon upon sensing a difference between the sensed level of the first wavelength is lower by at least a predetermined amount than the sensed level of the second wavelength.

In certain embodiments the illuminating by the first and second laser lights is performed by sequentially illuminating the area or volume of interest by a first pulse of laser light of the first wavelength followed by illuminating the area or volume of interest by a second laser pulse of the second wavelength.

Optionally, in order to obtain distance information to objects and/or the weather phenomenon, the method further comprises measuring a time difference between a pulse initiation time where time the first or the second pulse is initiated and a detection time of the respective pulse where the reflected respective pulse is sensed.

In yet another aspect of the invention there is provided a LIDAR (Laser Imaging Detection and Ranging) device comprising a first laser emitter capable of illuminating the volume of interest with laser light pulses having a first wavelength, a focal plan photodetector comprising a plurality of pixels each pixel being capable of sensing laser light reflected from the volume of interest, a focusing mechanism capable of focusing reflected light from the volume of interest onto the photodetector, such that each pixel receives light from a respective portion of the volume of interest, at least one timer capable of measuring time difference between an initiating of a laser pulse and a time when the laser pulse reflected from the volume of interest is sensed by at least one pixel, the LIDAR being characterized by a second laser emitter capable of illuminating the volume of interest with laser light pulses having a second wavelength, and at least one pixel of the photodetector is capable sensing laser pulses of the second wavelength. Thus such embodiments form a multiple wavelength LIDAR.

Optionally the first wavelength having a higher absorption by a weather phenomenon than the second wavelength, and the second wavelength having a higher reflectance rate by the weather phenomenon than the first wavelength. Asw described such optional embodiment provides for a LIDAR capable of detecting weather phenomenon within the volume of interest.

In certain embodiments the LIDAR may also sense thermal and other IR information. To that end at least one of the plurality of pixels is capable of detecting infrared energy when the photodetector is biased at a first polarity, and of detecting light at least at the first and second wavelengths when the photodetector is biased at a second polarity.

In an aspect of the invention therefore there is provided a combined LIDAR and infrared (IR) thermal energy sensor comprising at least one laser emitter capable of illuminating the volume of interest with laser light pulses, a focal plan photodetector comprising a plurality of pixels, a focusing mechanism capable of focusing IR thermal energy and reflected light from the volume of interest onto the photodetector, such that each pixel receives IR thermal energy and light from a respective portion of the volume of interest, at least one timer capable of measuring time difference between an initiating of a laser pulse and a time when the laser pulse reflected from the volume of interest is sensed by at least one pixel, the combined LIDAR is characterized by at least one of the plurality of pixels being capable of detecting infrared energy when the photodetector is biased at a first polarity, and of detecting light at least at the first and second wavelengths when the photodetector is biased at a second polarity. A sensor where a plurality of the pixels are capable of detecting infrared energy may provide a combined LIDAR 3D image and thermal 2D image, to form a thermal 3D map.

Optionally in the combined sensor the at least one laser emitter capable of emitting laser light pulses having a first wavelength, the sensor further comprising a second laser emitter capable of emitting laser light pulses having a second wavelength. Further optionally, the first wavelength having a higher absorption by a weather phenomenon than the second wavelength, and the second wavelength having a higher reflectance rate by the weather phenomenon than the first wavelength.

An aspect of the invention provides a device for detection of weather phenomenon selected from snow, ice, fog, rain, cloud, or any combination thereof, utilizing laser light. In that aspect there is provided a device comprising a first laser emitter capable of transmitting laser light at a first wavelength, a second laser emitter capable of transmitting laser light at a second wavelength, the first wavelength having a higher absorption by the weather phenomenon than the second wavelength, and the second wavelength having a higher reflectance rate by the weather phenomenon than the first wavelength; the first and second emitters being configurable to emit laser pulses in substantially the same direction, and a photodetector module capable of sensing reflected laser light pulses from the first and second emitters respectively.

Optionally the first wavelength is about 0.9 μm or about 1.8 μm. Further optionally the second wavelength is about 1.55 μm. Further optionally the laser emitter wavelengths are in the SWIR range in frequencies that are eye safe.

In another aspect of the invention there is further provided a method of forming a three dimensional (3D) thermal map of a volume of interest comprising illuminating the volume of interest utilizing at least one laser light; sensing laser light reflected from the volume of interest by a photodetector operating in a first mode, and sensing a thermal image from the volume of interest by the same photodetector operating in a second mode. In some embodiments operating the photodetector in the first mode comprises biasing the photodetector in a first polarity and operating the photodetector is the second mode comprises biasing the photodetector at a second polarity.

To that end as well as for other uses, there is provided a photodetector capable of sensing light in the first mode from 900 nm to 3500 nm and in the second mode from 4400 nm to 5200 nm.

### SHORT DESCRIPTION OF DRAWINGS

The summary above, and the following detailed description will be better understood in view of the enclosed drawings which depict details of preferred embodiments. It should however be noted that the invention is not limited to the precise arrangement shown in the drawings and that the drawings are provided merely as examples.

FIGS. 1A and 1B depict albedo of snow in different ages and water consistencies.

FIG. 2 depicts schematically a block diagram of a detection device utilizing multiple wavelength LIDAR, which is also capable of detecting a weather phenomenon.

FIG. 3 depicts a simplified flow diagram of detecting a weather phenomenon.

FIG. 4 depicts schematically a LIDAR and thermal imager based detection apparatus utilizing a single photodetector.

FIG. 5 depicts a simplified schematic diagram of a readout circuit of a single pixel, in accordance with an aspect of the invention.

FIG. 6 depict a simplified cross-section of an optional constructions of a combined thermal imaging and LIDAR photodetector

FIGS. 7A, 7B, and 7C depict examples of band diagrams of a combined thermal imaging LIDAR detector in accordance to certain aspects of the invention.

### DETAILED DESCRIPTION

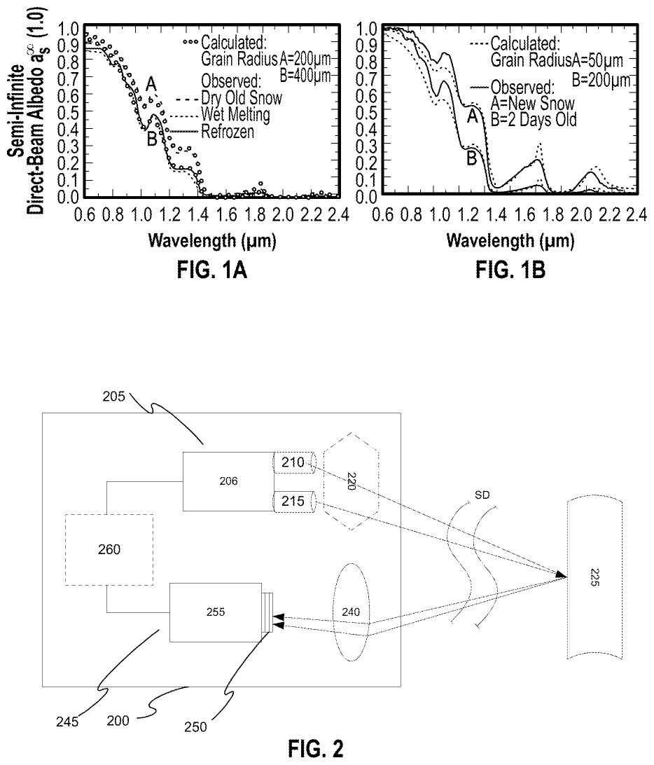

FIGS. 1A and 1B are extracted (and enhanced for readability) from “Wiscombe, W. J. & Warren, S. G. A Model for the Spectral Albedo of Snow. I: Pure Snow. Journal of the Atmospheric Sciences 37, 2712-2733 (1980)”. FIGS. 1A and 1B depict albedo of snow in different ages and water consistencies. Albedo is the proportion of light scattered, of a direct beam of light at various wavelengths illuminating snow in several relevant environments. Specifically, FIG. 1A compares spectral albedo at various water contents of snow from dry old snow to wet melting snow and to refrozen snow. FIG. 1B compares spectral albedo of new snow to two days old snow. In all the depicted environments in FIGS. 1A and 1B both the observed and calculated data show a very high proportion of scattering for the 905 nm wavelength light (albedo of 0.7-0.9) or 1800 nm and a very low scattering for the 1550 nm light (albedo of 0.0-0.1). Similar albedo characteristics exist in different grain sizes and depths, which while differing quantitatively, show similar absorption/reflectance patterns.

Certain embodiments shall now be described in detail in order to exemplify to the skilled in the art some of the advantages provided by the invention, and assist in its understanding and utilization.

FIG. 2 depicts schematically a simplified block diagram of multiple wavelengths LIDAR, which is also capable of detecting the existence of a weather phenomenon such as snow, ice, and the like. The apparatus 200 comprises a transmitter 205 having a transmitter logic and control module 206 which controls at least two laser emitters 210 and 215 respectively. The emitters are capable of transmitting laser light at differing wavelengths from each other.

An optional scanning mechanism 220 such as rotating mirrors and/or prisms directs the laser pulses from the emitters 210, 215 to a volume of interest, limited by a field of view of interest. Alternatively, the scanning mechanism is obviated by utilizing a beam expander such as a diverging lens, to illuminate the whole volume of interest in a single light pulse, colloquially referred to as a “flash”. Utilizing a flash allows illuminating a complete scene with a single pulse. Preferably the pulse is of high intensity, such as 1 micro-joule, 1 mili-joule or even 1 joule by way of example. Judicious selection of the wavelength allow utilization of eye safe wavelength and the fact that the energy is distributed over a larger area further reduces risks to an eye within the volume of interest. A beam expander may comprise at least one diverging lens to spread the laser light to fit the Field of View. Notably the volume of interest may be of any desired size.

Laser pulses may be of wide variety of durations such as a pulse shorter than 1 ns or even shorter than 0.5 ns, to pulses shorter than 10 ns, 100 ns, 500 ns, and 1 μs, and even to pulses longer than 1 μs, such as 2 μs, 5 μs, and more. In certain embodiments the laser pulses may be AC modulated.

Generally, transmitter logic 206 controls the firing rate, pulse length, intensity, and other parameters of the emitted laser pulses. The emitters are operated at different times, so that the receiver control circuitry 255 may differentiate the source of any reflected laser light. While the figure is schematic and not to scale in general, the squiggle lines marked SD indicates a scale discontinuity, as commonly the distance to the target is far greater than the distance between the emitters and detectors.

When the laser pulse of the highly reflected emitter hits a target, such as 225, at least a portion of the transmitted energy is returned to the receiver 245 and after being focused onto photodetector 250 by focus element 240, is detected by photodetector 250, the output thereof is read by receiver control circuitry 255.

In certain embodiments the LIDAR system merely detects the fact that a reflected pulse exceeding a certain threshold occurred, and measures the time between the pulse transmission and the detection of the reflected pulse. In other embodiments the LIDAR system detects the amplitude of the reflected pulse returned. In flash type LIDAR the photodetector comprises a plurality of pixels, and the system is capable of detecting the time difference between the time a laser pulse is transmitted and the time a reflected laser pulse is detected for each of the plurality of pixels.

Multiple wavelength LIDAR is advantageous for numerous applications, including by way of example allowing operations with high intensity at wavelengths which may be harmful to humans and animals when no risk of such operation exist, while switching to different wavelength when such risk exists.

Yet another advantage of multiple wavelengths LIDAR is directed at detection of weather phenomena such as snow, cloud, fog, rain, ice, and the like. In such embodiments the wavelength emitted by the first emitter 210 is selected to be highly absorbed by the phenomenon to be detected, while the wavelength of the second emitter 215 is selected to be highly reflected by the weather phenomenon. Clearly the terms highly absorbed and highly reflected should be construed as opposing relative to each other—a highly absorbed wavelength implies lower reflected wavelength and vice versa, thus the selection criteria may be differently stated as the first wavelength being highly absorbed than the weather phenomenon than the second wavelength, and conversely the second wavelength being highly reflected, more than the first wavelength. It is noted that the terms highly absorbed and highly reflected are not a measure of degree but a relative measure of the relative absorption and reflectivity respectively of any two selected frequencies, by the environment in the volume of interest. By way of a non-limiting example the highly absorbed wavelength may be about 1550 nm or about 1800 nm while the highly reflected wavelength may be about 900 nm or about 1800 nm. Generally transmitter logic 205 controls the firing rate, pulse length, intensity, and other parameters of the emitted laser pulses. The emitters are operated at different times, so that the receiver control circuitry 255 may differentiate the source of any reflected laser light.

If both emitters transmit towards the target but only the highly reflected laser light wavelength is detected, it is indicative that the direction from which the highly reflected pulse is detected contains the weather phenomenon, while reflectance of light from both emitters would indicate lack of the phenomenon. Range to the phenomenon may be estimated by the time of flight of the reflected laser pulse. It is important to note that the results may be binary or more likely differential, as some energy of the reflected wavelength shall be absorbed while some energy of the absorbed wavelength may be reflected back and detected by the photodetector. Therefore the determination of the existence or non-existence of the weather phenomenon in the field of view of interest is related to the differences between the detected first and second reflected wavelengths.

In certain embodiments the principle of detection of the weather phenomenon is utilized at a small area. By way of example it may be desired to detect the presence of ice on an aircraft wings, control surfaces, and/or fuselage. To that end the scanning mechanism 220 or a beam expander is optional, and in some embodiments even the focus mechanism 240 is optional. The detection of ice may be carried out on a single spot. Alternatively the scanning mechanism 220 may form a line scan or be directed to scan the entire volume of interest as done in a LIDAR described above. Similarly flash type detection mechanism may be utilized.

Focus mechanism 240 may take any desired form, from a ‘pinhole aperture’ to lenses, fiber bundle, and the like. The focus mechanism directs light and/or thermal energy from the volume of interest such that each pixel receives such light and/or thermal energy from a differing portion of the volume of interest. While the portions that each pixel receives may overlap in some areas, different pixels receive, as a whole, energy from a different portion from the adjacent pixels.

The operation of the LIDAR and/or the weather phenomena device is controlled by system controller 260. System controller 260 controls the transmitter 205 and the receiver 245, as well as communications with systems such as display, vehicle control systems, general communications, and the like. It is noted that the division between the transmitter 206 and receiver 245 controls may be integrated within the system controller 260 at various levels of integration from having all functionality within the system controller, to merely being housed in communication therewith. Furthermore system controller 260 may be located remotely to the LIDAR device. In some embodiments system controller 260 also creates the two or three dimensional representation of the volume of interest, colloquially known as a ‘map’ or an ‘image’ of the LIDAR.

In flash type LIDAR the Read-Out Circuit (ROC) of each pixel in the photodetector is capable of either measuring, or storing a charge proportional to, the time between the transmitted laser pulse and the detection of its reflected representation.

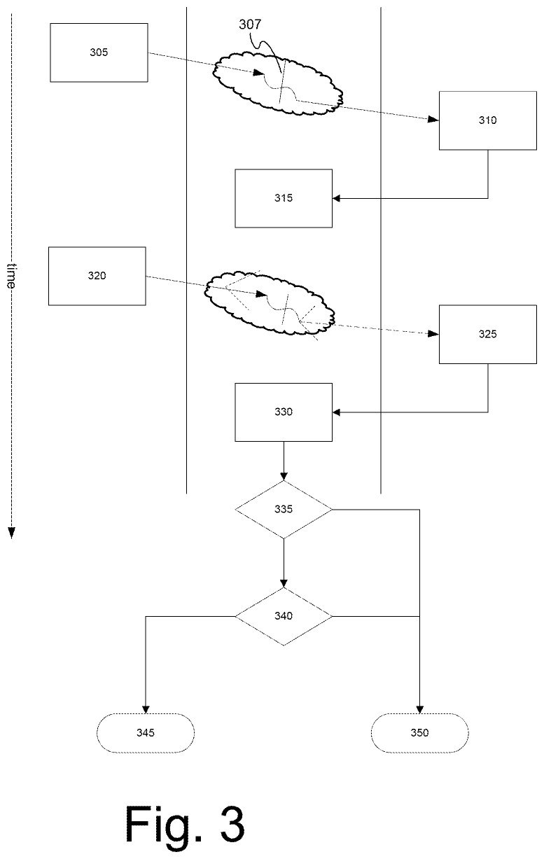

FIG. 3 represents a simplified block diagram along a simplified, and not to scale, timeline of occurrences between the transmitters 205, the receiver 245 and the system controller 260 in a system as depicted in FIG. 2. The operation begins when the system controller instructs the transmitter 205, and the transmitter sends 305, a laser pulse P₁ of highly reflected wavelength from emitter 215. The pulse is reflected 307 either by an object ort by the weather phenomenon itself, and is detected 310 by the receiver 245. As the wavelength is not absorbed by phenomenon (depicted as a ‘cloud’ in the drawing) the pulse is detected at reasonable amplitude which is noted and reported to the system controller. In this embodiment the time of flight T₁ is measured 315 by the system controller 260. Next, the system controller 260 instructs the transmitter 205 to transmit a second laser pulse P₂, this time of highly absorbed wavelength from emitter 210. In contrast with the highly reflective wavelength pulse P₁, P₂ is absorbed in whole or in part by the phenomenon, and thus the receiver detects a reduced energy return or no return at all. The flight time T₁ may be utilized to limit the time until the pulse P₂ is considered ‘lost’. The system controller 260 either utilizes the amplitude information of the returned pulse P₂ as compared to the strength of the returned pulse P₁, or the lack of detection of pulse P₂ altogether, to detect the existence of the phenomenon or lack thereof. If a pulse is detected 335 and the amplitude difference between the returns of P₁ and P₂ does not exceed a certain level, the phenomenon is considered not to be present. In contrast if the pulse P₂ is not detected 335 or the returned pulse amplitude difference P₁-P₂ is higher than a certain level, the phenomenon is assumed to be present in the direction the laser pulses were directed at. In a scanning LIDAR repeated operation in a scanning pattern of the field of view of interest allows the collection of a 3D map information to offer detection of the phenomenon. In a flash type LIDAR a single pulse is utilized to illuminate the volume of interest and information regarding the time-of-flight detected by each individual pixel of the plurality of pixels. Other options of such device are not depicted, in order to facilitate understanding of the principle of the detection of such phenomena by a multi-frequency LIDAR.

By way of example, highly absorbed wavelength may include wave of about 1550 nm and 2000 nm, while highly reflected wavelength may include waves of about 905 nm and 1800 nm. While the above wavelengths are indicated as a single wavelength, it is noted that those wavelengths are approximate and encompass wavelengths longer or shorter than indicated, which provide similar functionality. Similarly, other wavelengths may be selected, as long as the selection allows operation of the phenomenon detection according to the principles disclosed herein. The selection of wavelength is primarily a matter of technical choice as long as the absorbance of one wavelength as compared to the reflectance of the other provide sufficient difference to discern the existence of the weather phenomenon, or lack thereof. Furthermore, the system controller may alternate between scanning an entire field of view by one emitter and only then scan the field of view by the other emitter causing an interleaved frame scan between the two wavelengths. Alternatively, any desired scanning order may be utilized, such as alternating between the emitters for each direction during the scan of a single orientation, a single line, half a frame or a full frame, by way of example.

The utilization of LIDAR to provide three dimensional representation of the field of view of interest may be further enhanced by thermal imaging, as identifying certain types of objects utilizing thermal data is relatively simple. By way of example, since living creatures exert dark thermal energy, they are relatively easy to discern. As different materials absorb heat differently, the thermal image allows differentiating between different materials such as asphalt and sand, by way of example. However thermal images are generally two dimensional and lack depth information. Combining the information derived from LIDAR 3D representation and thermal imaging information enabled formation of a three dimensional (3D) thermal map. Such 3D thermal map may utilized for various purposes such as creating a combined actual image for display, analysis by software for collecting information about the field of view, selection of a path, object avoidance, and the like.

Combining such LIDAR and thermal images is a complex process when the information is derived by separate detectors, due to parallax. However if the detection is done by a single sensor the combination of thermal and LIDAR data becomes far simpler—the same pixel will generally generate the thermal information for the object detected by the LIDAR information. This may be achieved by an aspect of the invention that utilizes a single detector to detect LIDAR and thermal image data. As previously stated, the fusion of the LIDAR and the Thermal information forms an apparatus which is very useful for applications within moving vehicles, and more so within an autonomous vehicle. The thermal image information facilitates discerning animate from inanimate objects while the LIDAR information provides an exact distance from the object. Therefore, the data transmitted from such apparatus offers significant advantageous to autonomous vehicles or any autonomous device as it allows discerning humans from surroundings as well as discerning the difference between objects of different temperature or emissivity. The ability to detect snow and hazardous conditions makes such combined LIDAR and thermal apparatus even more useful.

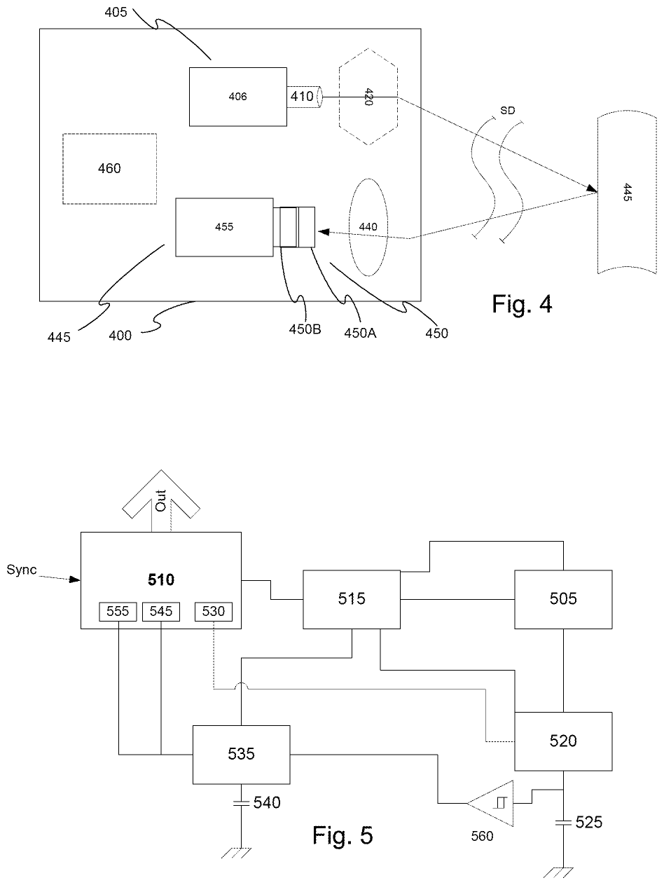

FIG. 4 depicts a simplified block diagram of a combined LIDAR and thermal detector apparatus 400. The apparatus comprises a transmitter 405 having a transmitter logic and control module 406 which controls at least one laser emitter 410. A scanning mechanism 420 such as rotating mirrors and/or prisms or actual moving of the laser itself, directs the laser pulses from the emitter 410 to a field of view of interest, which may be of any size. Generally transmitter logic 206 controls the firing rate, pulse length, intensity, and other parameters of the emitted laser pulses. As explained above regarding scanning mechanism 220, a mechanism such as 420 may be replaced by a beam expander, allowing illuminating of a much wider filed, covering a larger volume and potentially the entire volume of interest. While the figure is schematic and not to scale in general, the squiggle lines marked SD indicates a scale discontinuity, as commonly the distance to the target is far greater than the distance between the emitters and detectors.

When the laser pulse of the emitter 410 hits a target, such as 425, at least a portion of the transmitted laser energy is returned to the receiver 445 and after being focused onto a photodetector by focus element 240.

The photodetector 450 in this embodiment, while occupying a combined volume, may be considered as two superimposed photodetectors 450A and 450B respectively. Receiver control 455 controls the operation of the receiver 445 and includes inter alia a readout circuitry. When the photodetector 450 is biased at a first polarity the detector is operative to detect at least the wavelength of the laser pulse emitted from emitter 410, and when biased at a second polarity, the detector is operative to detect wavelengths at mid IR range, at a wavelength for example between 4400 nm-5200 nm, a range which for brevity shall be equivalently referred to as HOT-MW and/or MWIR.

The use of a single detector detection of detect both the LIDAR wavelength and the thermal HOT-MW wavelength provides yet another advantage, according to an aspect of the invention, namely the ability to receive thermal imaging and LIDAR information with a small temporal distance therebetween, thus facilitating formation of 3D thermal with increased accuracy. Further, in such embodiment the LIDAR may be a single wavelength or utilize a plurality of wavelengths, all of which are detected by the same photodetector together with black body energy in the HOT-MW range.

Combining the thermal and LIDAR information involve two potential sources of parallax. The first is the common optical parallax stemming from one sensor being disposed at a different physical location than a second sensor. The second ‘parallax’ source shall be termed a temporal parallax, does not strictly stemming from distance between the sensors, and thus strays somewhat from the strict definition of parallax, stems from motion over a time difference between the time an image is obtained from the first sensor and an image obtained by the second sensor. The resultant displacement of similar objects is somewhat similar to the optical parallax, and thus this phenomenon shall be termed a ‘temporal parallax’.

The use of a single photodetector in certain aspects of the invention overcomes the optical parallax for most practical purposes. However reducing the temporal parallax requires minimizing the time difference between acquiring the two images—namely the LIDAR and thermal images.

Information obtained by photodetectors is transformed by circuitry colloquially known as a Digital or non-Digital Read-Out circuit (DROIC, ROIC). In common LIDAR and thermal imaging systems the readout circuitry of the detector stores a single frame of reflected laser's pulses, and then output the frame data to other electronic circuitry for further processing and/or storage. For brevity the other electronic circuitry shall be termed ‘processing circuitry’ which extends to a local as well as remote circuitry, and which may perform other functions. The time difference between frames in the above described method may be 200 microseconds or larger, since communicating each frame requires time for the readout to communicate with the processing circuitry.

An aspect of the invention involves the read-out circuitry storing a plurality of individual frames, each representing differing wavelength, prior to transferring the stored data to the processing circuitry. Thus if the apparatus utilizes a thermal data frame and a LIDAR data frame, a plurality of LIDAR data frames each from a different emitters, or a combination multi-wavelength LIDAR and thermal frames. Since no communication is required between the DROIC circuitry and the processing circuitry is eliminated between capture of subsequent frames of a different wavelength the temporal parallax is greatly reduced, and in certain applications may be completely ignored. By way of example the time difference between frame capture may be reduced to 5 microseconds and bellow. While transferring the data between the RDOIC and the processing circuit may stay the same, the effects of motion of the sensing apparatus and/or objects in the field of view of interest are greatly diminished.

FIG. 5 described a simplified block diagram of exemplary construction of such read-out circuitry for a single pixel (PROC). A pixel controller 510 may be embodied as a single pixel controller but more commonly is embodied as a single controller for a plurality of pixels, with control lines coupling it to individual pixel control cells. For brevity this disclosure would describe the operation of the PROC as if each pixel cell having its own controller, unless specifically indicated otherwise. The pixel controller is coupled to a switching circuit 515 which controls switching of certain signals and biases within the PROC. The pixel controller receives a sync signal indicating the initiation of a laser pulse by the laser emitters. Assuming a first frame comprising thermally sensed information the controller 510 signals the switching circuit 515 sets up the mode of operation of the pixel's photodetector 505 to sense thermal information by biasing the photodetector at a first polarity. The output of the photodetector is collected in intensity integration capacitor 525 via intensity capacitor controller 520. After a selected integration period, the intensity capacitor controller 520 senses the charge collected in the intensity integration capacitor 525, and stores the charge information in the first information storage unit 530. This concludes the collection of the pixel first (thermal) frame activity. The intensity capacitor controller also discharge the integration capacitor 520 to ready it for collecting information for the next frame.

The system than begins the capture of the second frame, where the system controller activates the first laser emitter, and sends a sync signal to the controller 510. Controller 510 in turn commands the switching unit 515 to bias the photodetector pixel 505 in a second polarity, at which it can detect the laser wavelengths. Simultaneously, the switching unit 515 triggers a timer 535 which begins charging a timing capacitor 540 at a known rate. The detected signal is again integrated by the intensity integration capacitor 520, and charge is collected therein. When the charge reaches a predetermined or selectable level, a trigger 560 is activated and indicates to the timer that a reflected pulse has been detected. The timer evaluates the time since being triggered, and stores this timing information in a second storage unit 545. The timing capacitor and the intensity integration capacitors are again discharged to ready the system for the third frame. The third frame operation is identical is identical to the second frame except for storing the timing information in a third storage unit 555.

In certain embodiments the PROC also detects and stores the intensity of the reflected signal in the second and third frames. In such embodiments the intensity integration capacitor 520 is read at the end of an integration period, and the intensity information is stored at the respective storage unit. Notably the integration period may vary between frames.

After obtaining information for the three frames the controller 510 may transfer information regarding the three frames to a processor for creating a 3D thermal map and the like.

Another aspect of the present invention involves a single photodetector capable of detecting wavelengths in the thermal and LIDAR ranges, or more precisely of a focal plane array photodetector comprising a plurality of pixels capable of such detection. It is noted that the photodetector disclosed herein is provided as an example, however the aspects of the invention disclosed herein may also be applied to other types of photodetectors.

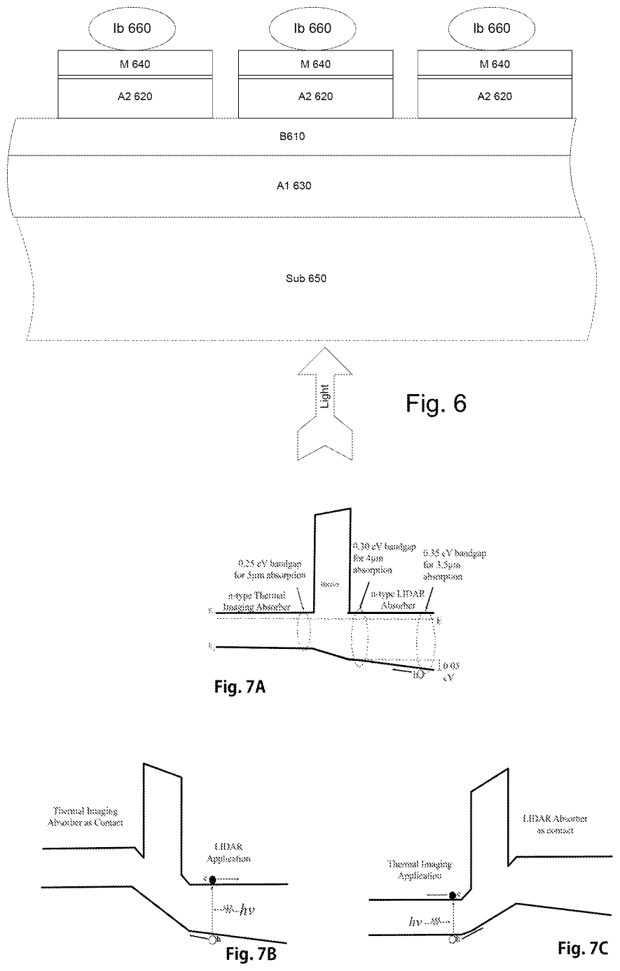

FIG. 6 depicts one optional construction of a photodetector capable of sensing the LIDAR laser pulses and a thermal energy in the ‘Hot’ mid-wave IR (MWIR). FIG. 6 is a cross-section of a representative portion of the photodetector, showing several pixels. The photodetector utilizes two separate photoabsorbers, deposited on two sides of a barrier layer. Selective activation of one photoabsorber or the other is achieved by biasing the photodetector in a first and second polarities respectively.

The detector is grown on a substrate 650 of GaSb, onto which a first absorber 630 is deposited the first absorber 630 is directed to detecting the laser LIDAR pulses, with a wavelength sensitivity cutoff of 3.5 μm, which can absorb both 905 nm and 1.55 μm laser pulses as well as other wavelengths which may be selected for the LIDAR laser emitters. The first photoabsorber 630 is deposited onto the substrate 650 beginning with depositing InAs/InAsSb sls-II for a resulting absorber initial layer having an initial layer of Eg=0.35 eV at a temperature of 150K. The deposition continues with linear grading over 0.5 μm to Eg=0.3 eV. The linear grading is done by changing the period composition of the InAs/InAsSb sls-II. The linear grading of the LIDAR absorber is made to increase the response time of the detector, making it faster. To understand this, the following equations show the diffusion time for holes.

v_{drift}=μ*E

Assuming a 0.5 μm absorber, a grading of 0.05 eV, and a hole mobility of 200 cm2/Vs at 150K, the drift velocity due to grading is 2×10\hat{ }5 cm/s, which results in a cross time of the LIDAR absorber of 0.25 ns resulting in a very fast detector.

A barrier 610 comprising AlAsSb is then deposited on top of the first absorber 630. The second absorber 620 is then deposited on top of the barrier. The second absorber is not contiguous, and comprises an individual absorber for each pixel. The separation between the second detectors 620 of each individual pixel detectors may be achieved by selective deposition or by subsequent selective etching.

Notably, the present photodetector utilizes some technologies disclosed in U.S. Pat. No. 7,687,871 to one of the present inventors, and which is incorporated herein by reference. U.S. Pat. No. 7,687,871 describes inter alia a photodetector with reduced dark current utilizing a barrier which eliminates the requirement for etching of the barrier 610 and the bottom absorber 630, thus resulting in the barrier passivating the bottom 630 and top 620 absorbers.

The second absorber 620 is utilized for sensing thermal energy (MWIR) and is constructed by depositing InAs/InAsSb (3 nm/2 nm with 25% Sb concentration, for example) on top of the barrier, with a thickness in the order of 2 μm. The Absorber 620 shall have a cutoff wavelength of about 5.2 μm, and is well suited for the Hot MW, MWIR range.

A metal contact 640 is then deposited on top of the second absorber 620. Optionally a small amount of indium, known colloquially as an ‘indium bump’ 660 is deposited on top of the metal layer to ease connection to the ROIC, such as by a ‘flip-chip’ connection method.

Optionally a process of substrate 650 removal or thinning is utilized to minimize blockage of light which may prevent light from penetrating into the sls-II, in a bottom-illumination system.

The ROIC can then selectively activate the first and second photoabsorber. Activation of the top absorber 620 is done by applying a negative charge to the contact 640 and a positive charge to the bottom absorber 630 resulting in negatively biasing the top absorber, and causing sensing of LIDAR laser wavelengths. Conversely, connecting a positive charge to the contact 640 and a negative charge to the bottom absorber 630 would result in positively biasing the top absorber, and causing thermal MWIR sensing. Optionally, peripheral indium bumps are utilized for achieving the electrical connection to the bottom absorber 630.

FIG. 7A is a band diagram of a pixel in the photodetector operated in Thermal imaging mode. FIG. 7B is a band diagram of a pixel in the photodetector operated in zero bias. FIG. 7C is a band diagram of a pixel in the photodetector operated in LIDAR mode.

Unless otherwise specified, relational terms used in these specifications should be construed to include certain tolerances that the skilled in the art would recognize as providing equivalent functionality. By way of example the term perpendicular is not necessarily limited to 90.0°, but also to any slight variation thereof that the skilled in the art would recognize as providing equivalent functionality for the purposes described for the relevant member or element. Terms such as “about” and “substantially” in the context of configuration relate generally to disposition, location, or configuration that is either exact or sufficiently close to the location, disposition, or configuration of the relevant element to preserve operability of the element within the invention which does not materially modifies the invention. Similarly, unless specifically specified or clear from its context, numerical values should be construed to include certain tolerances that the skilled in the art would recognize as having negligible importance as it does not materially change the operability of the invention.

In these specifications reference is often made to the accompanying drawings which form a part of the disclosure, and in which are shown by way of illustration and not of limitation, exemplary implementations and embodiments. Further, it should be noted that while the description provides various exemplary embodiments, as described below and as illustrated in the drawings, this disclosure is not limited to the implementations described and illustrated herein, but can extend to other embodiments as would be known or as would become known to those skilled in the art. Reference in the specification to “one embodiment”, “this embodiment”, “these embodiments”, “several embodiments”, “selected embodiments” or “some embodiments” means that a particular feature, structure, or characteristic described in connection with the embodiment(s) may be included in one or more implementations, and the appearances of these phrases in various places in the specification are not necessarily all referring to the same embodiment(s). Additionally, in the description, numerous specific details are set forth in order to provide a thorough disclosure, guidance and/or to facilitate understanding of the invention or features thereof. However, it will be apparent to one of ordinary skill in the art that these specific details may not all be needed in each implementation. In certain embodiments, well-known structures, materials, circuits, processes and interfaces have not been described in detail, and/or may be illustrated schematically or in block diagram form, so as to not unnecessarily obscure the disclosure.

For clarity the directional terms such as ‘up’, ‘down’, ‘left’, ‘right’, and descriptive terms such as ‘upper’ and ‘lower’, ‘above’, ‘below’, ‘sideways’, ‘inward’, ‘outward’, and the like, are applied according to their ordinary and customary meaning, to describe relative disposition, locations, and orientations of various components. When relating to the drawings, such directional and descriptive terms and words relate to the drawings to which reference is made. Notably, the relative positions are descriptive and relative to the above described orientation and modifying the orientation would not change the disclosed relative structure.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

What is claimed is:

1. An apparatus for detecting a weather phenomenon in a volume of interest, the apparatus comprising:
a first laser emitter capable of illuminating the volume of interest with laser light pulses having a first wavelength;
a second laser emitter capable of illuminating the volume of interest with laser light pulses having a second wavelength;
a focal plan photodetector comprising a plurality of pixels each pixel being capable of sensing reflected laser light pulses from the first and second emitters respectively and of receiving light from a respective portion of the volume of interest;
a focusing mechanism capable of focusing reflected light from the volume of interest on the photodetector, such that each pixel receives light from a respective portion of the volume of interest;
a comparator configured to compare relative amplitude of the reflected light of first and second wavelengths detected by the photodetector;
the first wavelength having a higher absorption by the weather phenomenon than the second wavelength, and the second wavelength having a higher reflectance rate by the weather phenomenon than the first wavelength.

2. The apparatus of claim 1, wherein at least one of the plurality of pixels is capable of detecting infrared energy when the photodetector is biased at a first polarity, and of detecting light at least at the first and second wavelengths when the photodetector is biased at a second polarity opposite the first polarity.

3. The apparatus of claim 2, wherein the infrared energy is a black body energy.

4. A method of detecting the existence of a weather phenomenon in an area or volume of interest, the method comprising:
illuminating the area or volume of interest by a laser light of a first wavelength;
sensing the laser light of first wavelength reflected from the area or volume of interest;
illuminating the area or volume of interest by a laser light pulse of a second wavelength;
sensing the laser light of second wavelength reflected from the area or volume of interest;
the first wavelength having a higher absorption by the weather phenomenon than the second wavelength, and the second wavelength having a higher reflectance rate by the weather phenomenon than the first wavelength;
and indicating the presence of a weather phenomenon upon sensing a difference between the sensed level of the first wavelength is lower by at least a predetermined amount than the sensed level of the second wavelength.

5. The method of claim 4 wherein the illuminating by the first and second laser lights is performed by sequentially illuminating the area or volume of interest by a first pulse of laser light of the first wavelength followed by illuminating the area or volume of interest by a second laser pulse of the second wavelength.

6. The method of claim 5 further comprising measuring a time difference between a pulse initiation time where time the first or the second pulse is initiated and a detection time of the respective pulse where the reflected respective pulse is sensed.

7. The method of claim 4 wherein the step of sensing is performed by a focal plan photodetector comprising a plurality of pixels each pixel being capable of sensing reflected laser light pulses from the first and second emitters respectively, and of receiving light from a respective portion of the volume of interest

8. A LIDAR (Laser Imaging Detection and Ranging) device comprising:
a first laser emitter capable of illuminating the volume of interest with laser light pulses having a first wavelength;
a focal plan photodetector comprising a plurality of pixels each pixel being capable of sensing laser light reflected from the volume of interest and of receiving light from a respective portion of the volume of interest;
a focusing mechanism capable of focusing reflected light from the volume of interest onto the photodetector, such that each pixel receives light from a respective portion of the volume of interest;
at least one timer capable of measuring time difference between an initiating of a laser pulse and a time when the laser pulse reflected from the volume of interest is sensed by at least one pixel;
a second laser emitter capable of illuminating the volume of interest with laser light pulses having a second wavelength, and,
at least one pixel of the photodetector is capable sensing laser pulses of the second wavelength.
